(19) United States
(12) Patent Application Publication
(10) Pub. No.: US 2002/0185426 A1
(43) Pub. Date: Dec. 12, 2002

(54) Environmental flexible remediation system

(76) Inventor: LeRoy J. Bealer JR., Nazareth, PA (US)

Correspondence Address: LeRoy J. Bealer Jr., 2144 Fieldview Drive, Nazareth, PA, 18064, US

(21) Appl. No.: 10/127,965

(22) Filed: Apr. 22, 2002

Related U.S. Application Data
(60) Provisional application No. 60/286,795, filed on Apr. 26, 2001.

(51) Int. Cl. C02F 9/00

(52) U.S. Cl. 210/259

(57) ABSTRACT

The invention provides a simple, compact water treatment structure that is easily modified to use a plurality of different treatment technologies in a cost-effective manner. The system is a multi-celled tank with access to each cell for the installation of selected treatment technologies. The cells are connected in series, so that each successively improves the condition of the water. Technologies that may be employed by this system include solids settling, oil-water separation, air stripping, carbon adsorption, biological degradation, filtration, and nutrient injection. A large mass of water is retained in a relatively small area to allow high retention times and efficient treatment of the water. Simple and reliable gravity control is used to for water flow through much of the system. A complete water treatment system may be constructed in a single vessel. Treatment technologies may be changed over the life of the system to maintain treatment and cost efficiencies. The invention may be used as a sump for traditional treatment systems for additional treatment capacity. This invention may be buried, installed on a portable device, or mounted above ground with minimal enclosure requirements. Buried installation provides thermal protection, physical protection, easy maintenance access, and saves space. The flexibility of the invention allows a proper initial design and sizing without the need to be too conservative, and maintains high operating efficiency over the life of the system.

### CROSS-REFERENCE TO RELATED APPLICATIONS

This application is entitled to the benefit of Provisional Patent Application Ser. No. 60/286795 filed Apr. 26, 2001.

### BACKGROUND

1. Field of Invention

This invention relates to water purification and conditioning. In particular, the invention concerns an advantageous structure, for treatment of contaminated water.

2. Description of Prior Art

The contamination of water has been an ever-increasing problem. For example, many industrial processes give rise to waste water streams having contaminants therein. Generally, such streams should be treated for the removal of contaminants, prior to their discharge into treatment works, lakes, rivers, groundwater, etc. Dump sites and underground storage tanks may leak into local groundwater. When this occurs, the groundwater often must be pumped and treated, to prevent the spread of contaminants by means of the groundwater system. Septic systems require the treatment of water prior to discharge to prevent contamination to the groundwater. Even rainwater that comes in contact with contaminated surfaces or airborne particles can produce water that is contaminated.

Three general classes of methods for removing contaminants from water have been developed. These are chemical treatments, biological treatments, and physical treatments. Each treatment class has several treatment technologies. Examples of physical treatment technologies include separation, settling, air stripping, and carbon adsorption. Designing a treatment system requires selecting one or more technologies to effectively treat the water of concern. But, it is difficult to accurately predict the condition of the water over the life cycle of the system. Conservative steady state assumptions are made and safety factors added to the design. This results in a conservative design that may significantly increase the capital and operating cost of the system.

In the groundwater treatment systems, the water conditions may change significantly over time. At a gasoline spill site, groundwater pumped into the treatment system may contain relatively high volatile organic concentrations at the start of operation. Over time, these concentrations in the pumped groundwater may significantly decrease. The system design parameters are often selected based on initial operating conditions and conservative, steady state assumptions. The system may be inefficient from the start, and become even more inefficient as groundwater concentrations decrease. To maintain operating efficiencies, changing water conditions may require changing treatment technologies. Changing to different treatment technologies require relatively significant capital expense.

Treatment systems often have significant space requirements and typically require some type of enclosure to protect the equipment from the weather. Many systems have complex sensor and control systems, which add to maintenance requirements and often lead to system shutdowns.

There have been some recent developments in improving water treatment systems. For example, the following patents are essentially efforts to improve water treatment system efficiency: U.S. Pat. No. 4,544,488 issues to O'Brien; U.S. Pat. No. 4,826,601 issued to Spratt et al.; U.S. Pat. No. 4,892,664 issued to Miller; U.S. Pat. No. 4,925,552 issued to Bateson et al.; U.S. Pat. No. 5,080,793 issued to Urlings; U.S. Pat. No. 5,173,092 issued to Rudder; U.S. Pat. No. 5,352,276 issued to Rentschler et al.; U.S. Pat. No. 5,614,086 issued to Hill et al.; and U.S. Pat. No. 6,077,448 issued to Tran-Quoc-Nam et al. These systems may be efficient over a limited operating range of water conditions, but their efficiency and cost effectiveness may decrease outside these ranges.

One method to decrease the expense of moving systems is demonstrated in U.S. Pat. No. 5,104,525 issued to Roderick, which describes a portable self-contained water remediation unit. But the remediation technology chosen is still fixed and may have limited, efficient operating ranges. This invention also has a plurality of sensors and control elements. This adds complexity to the system and may increase maintenance requirements.

### SUMMARY

The invention provides a simple water treatment structure that may be easily modified to utilize a plurality of different treatment technologies in a cost-effective manner.

Objectives and Advantages

Accordingly, several objects and advantages of my invention are:

(a) to provide a water treatment system that is flexible,

(b) to provide a water treatment system that successively treats water in a series of treatment cells with each successive treatment further improving the condition of the water,

(c) to provide a water treatment system that may change treatment technologies utilized during the operation of the system,

(d) to provide a water treatment system that can be sized appropriately,

(e) to provide a water treatment system that minimizes capital and operating expense,

(f) to provide a water treatment system that is compact and minimizes space requirements,

(g) to provide a water treatment system that allows and acts as a sump for the addition of conventional systems to add treatment capacity,

(h) to provide a water treatment system that can be buried to save space, enclosure costs, add thermal protection, and save operational expense,

(i) to provide a water treatment system that can be portable,

(j) to provide a water treatment system that can be installed above ground and with minimal if any enclosure requirements,

(k) to provide a water treatment system that is easy to maintain and clean,

(l) to provide a water treatment system that minimizes control and sensor requirements,

(m) to provide a water treatment system that uses gravity control and flow to maintain simple, cost effective, and reliable operation,

(n) to provide a water treatment system with high operational reliability,

(o) to provide a water treatment system that maintains long retention time of water in the system,

(p) to provide a water treatment system that may perform the remediation functions of solids settling, oil-water separation, air stripping, carbon adsorption, biological degradation, filtration, and nutrient injection,

(q) to provide a water treatment system that may condition and add constituents including surfactants, nutrients, and other compounds to water for re-injection into the ground for in-situ treatment technologies,

(r) to provide a water treatment system that due to its cylindrical shape has advantages over traditional systems including: high retention time, compact size, and space to allow significant solids settling,

(s) to provide a water treatment system that may be operated in a series of air stripping processes in a manner that is superior to current air stripping techniques,

(t) to provide a water treatment system that operating as an air stripper provides rotational flow in each stripping cell to enhance mixing and treatment of the water in the cell,

(u) to provide a water treatment system that may be installed permanently and be converted and utilized as a storm water treatment system,

(v) to provide a water treatment system that may collect and treat rainwater and allow the injection into the ground to provide additional rainwater recharge,

(w) to provide a water treatment system that anticipates improvements in future remediation technologies and is adaptable to them,

Further objects and advantages of my invention will become apparent from a consideration of the drawings and ensuing description.

### DRAWING FIGURES

FIG. 1 shows an isometric view of the invention in the preferred embodiment.

FIG. 2 shows the side view of the invention with carbon and biological packing material levels.

FIG. 3A shows the schematic of a four celled system and FIG. 3B shows the schematic of a six celled system.

FIG. 4A shows the schematic of a series system and FIG. 4B shows the schematic of a parallel system.

FIG. 5 shows the schematic of the invention with the addition of traditional remediation systems.

Reference Numerals in Drawings

| | |
|---|---|
| 1 | knock out cell |
| 2 | air stripper cell |
| 3 | carbon cell |
| 4 | biological treatment cell |
| 5 | nutrient injection cell |
| 6 | wall |
| 7 | man-way |
| 8 | port |
| 9 | influent |
| 10 | effluent pipe |
| 11 | system influent |
| 12 | system effluent pipe |
| 13 | submersible pump |
| 14 | water level control assembly |
| 15 | power supply and control conduits |
| 16 | water transfer pipe |
| 17 | vacuum vapor effluent |
| 18 | plug |
| 19 | stripper air supply |
| 20 | stripper elbow |
| 21 | stripper diffuser tube |
| 22 | stripper vapor effluent |
| 23 | screened pipe |
| 24 | carbon |
| 25 | nutrient injection pipe |
| 26 | nutrient air supply |
| 27 | nutrient elbow |
| 28 | nutrient diffuser tube |
| 29 | nutrient vapor effluent |
| 30 | biological packing media |
| 31 | injection pipe |
| 32 | water level during operation |
| 33 | traditional air stripper |
| 34 | traditional carbon vessel |

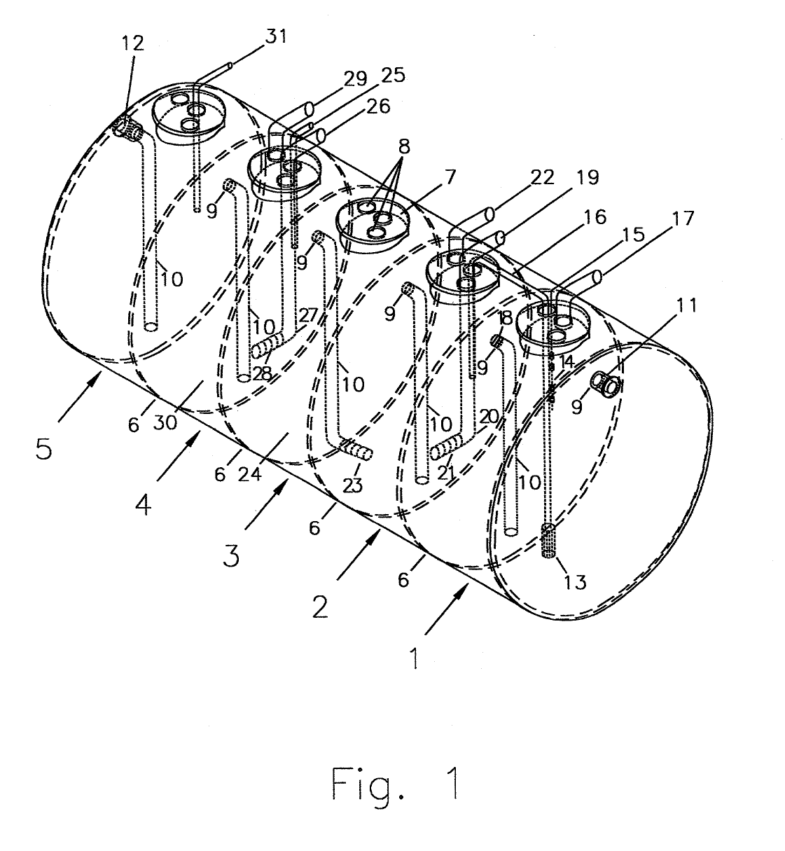

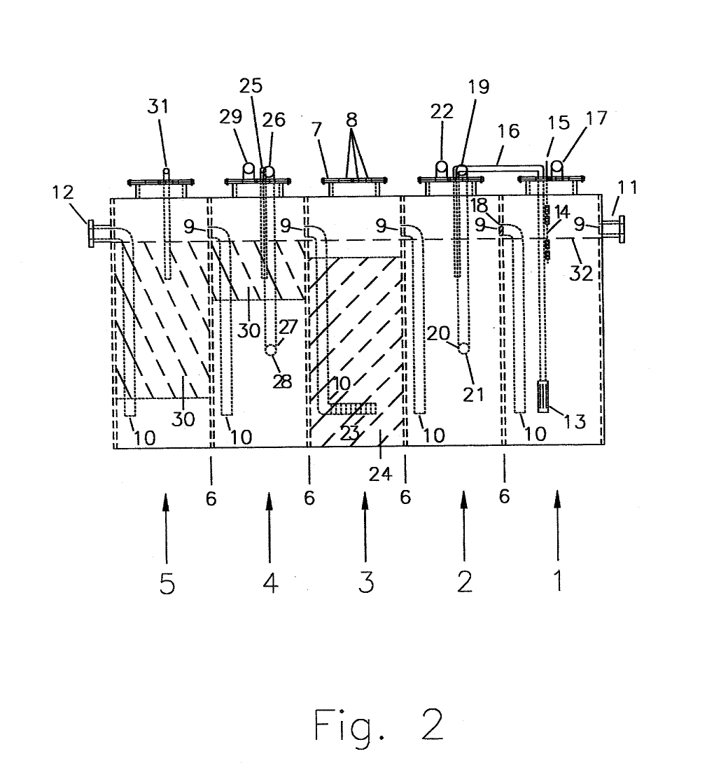

### DESCRIPTION—FIGS. 1 AND 2—PREFERRED EMBODIMENT

A preferred embodiment of the environmental flexible remediation system is shown in FIG. 1 and FIG. 2. The body is a 5000 gallon steel cylindrical tank, separated into five sections, or cells 1 to 5. Walls 6 inside the tank separate each cell. Each cell has an access man-way, opening, or hole 7 at the top of the cell. A lid, cover, or plate covers the manway and contains three 5″ diameter threaded holes or ports 8. Each cell has a 5″ diameter influent 9 located at the top section of one wall and a 5″ inch diameter effluent pipe 10 located near the lower section of the opposite wall. Each effluent pipe is connected through the wall and provides the influent to the subsequent cell at a height equal to the previous influent. The first cell's influent is the system's influent 11 and the fifth cell's effluent pipe is the system's effluent pipe 12 and both are through tank ends.

The first cell 1 is a knock out cell. A submersible pump 13 and a water level control assembly 14 are installed through a port in the manway cover. The water level control assembly 14 is four water sensors set up in a safe-high, high, low, and safe-low control logic. Power supply and control conduits 15 for the pump and level controls, and a 2″ diameter water transfer pipe 16 exit the cell through one port. The water transfer pipe is connected to the second cell 2 through a port in that cell. A 4″ diameter vapor effluent pipe 17 is installed through another port in the first cell. A 5″ diameter plug 18 is installed in the effluent pipe of the first cell.

The second cell 2 is an air stripper cell. A 4″ diameter air supply pipe 19 enters a port and extends approximately two thirds down the diameter of the cell. A ninety-degree elbow 20 connects the end of this pipe to a section of a diffuser tube 21. The diffuser tube is oriented perpendicular to the length of the tank. A 4″ diameter vapor effluent pipe 22 is installed through another port.

The third cell 3 is a carbon cell. A screened pipe 23 is connected to the bottom of this cell's effluent pipe. FIG. 2 shows the cell partially filled with granular activated carbon 24.

The fourth cell 4 is a biological treatment cell. It is constructed in the same manner as the air stripper cell with the addition of a 2″ diameter nutrient injection pipe 25. The injection pipe is installed through a port and extends a short distance into the cell. A 4″ diameter air supply pipe 26 enters a port and extends approximately two thirds down the diameter of the cell. A ninety-degree elbow 27 connects the end of this pipe to a section of a diffuser tube 28. The diffuser tube is oriented perpendicular to the length of the tank. A 4″ diameter vapor effluent pipe 29 is installed through another port. FIG. 2 shows the cell partially filled with a biological packing media 30, which floats in the water during operation of the system. The biological packing media are 3″ diameter plastics packing material of the type typically used in tower air strippers.

The fifth cell 5 is a nutrient injection cell. A 2″ diameter nutrient injection pipe 31 is installed through a port. FIG. 2 shows the cell partially filled with biological packing media 30, which floats in the water during system operation.

Operation of Preferred Embodiment

This invention operates by treating water in multiple stages and with multiple treatment techniques. Contaminated water enters the first cell and moves through each successive cell by either pumping or gravity flow. An operational feature of the preferred embodiment is the ability and flexibility to change the treatment techniques during the operational life of the system. The initial treatment techniques in the preferred embodiment include oil/water separation, air stripping, carbon adsorption, and nutrient injection. Different treatment techniques can be added or removed and used in any combination to maximize the performance of the system. The initial configuration of the preferred embodiment is described below.

Vacuum in the vapor effluent pipe 17 draws contaminated water and/or air into the first cell 1 through the system influent 11. Gravity separates the water and airflow streams. Air leaves the top of the cell through vapor effluent pipe 17. A submersible pump 13 located near the bottom of the cell pumps water into the second cell 2. The water level in the first cell is controlled by the water level control assembly 14, which consists of safe-high, high, low, and safe-low control logic. Lighter than water separate phase contaminants float and collect on top of the water in the cell. Precipitates and solids settle at the bottom of the cell. Access to each cell through the manway 7 and ports 8 allows easy maintenance, modifications, cleaning, and removal of contaminants, precipitates, and solids.

Water is pumped into the second cell 2 from the first 1 via the water transfer pipe 16. The air supply 19 to the cell injects air below the water through the diffuser tube 21. The diffuser tube creates air bubbles in the water and the bubbles float up through the water. The air bubbles strip contaminants from the water and create a mixing and rotational effect in the water. Precipitates and solids settle at the bottom of the cell. The stripped water gravity flows into the third cell 3 via the effluent pipe 10. Air is vented from the cell through the vapor effluent 22.

The water level in cells 2-5 are controlled and moved by gravity. The height of the effluent pipe's 10 discharge to the subsequent cell, controls the level of water during operation 32, shown in FIG. 2.

Water enters the third cell 3 at the cell's influent 9. The water gravity drains through the carbon 24 in the cell. Carbon treats the water as it passes through it. The screened pipe 23 attached to the effluent pipe 10 prevents carbon from entering the pipe while allowing water to pass through it. Carbon treated water gravity flows into the fourth cell 4 via the effluent pipe 10.

Water enters the fourth cell 4 at the cell's influent 9. Nutrients are added to the water through the nutrient injection pipe 25 and by air injection through diffuser tube 28. The nutrients added to the water increase the biological reactions to reduce contaminants in the water. Nutrients can be directly injected in a continuous or batch manner through the nutrient injection pipe 25. Nutrients can also be added through the flow of air through the water. Oxygen is one nutrient that can be added in this manner. The air injected through the diffuser tube 28 also mixes the nutrients and the water. The air floats through the water creating a mixing and rotational effect. Air is vented from the cell through the vapor effluent 29.

Precipitates and solids settle at the bottom of the cell. The biological packing media 30 float in the water and provide surface area for biological growth and treatment. Biologically treated and/or nutrient enhanced water gravity flows into the fifth cell 5 via the effluent pipe 10.

Water enters the fifth cell 5 at the cell's influent 9. Nutrients are added to the water through the nutrient injection pipe 31. The nutrients added to the water increase the biological reactions to reduce contaminants in the water. Nutrients can be added in a continuous or batch manner through the nutrient injection pipe 31. The biological packing media 30 provide increased surface area for biological growth and treatment. Treated and/or nutrient enhanced water gravity flows out of the fifth cell 5 via the effluent pipe 10 and is discharged from the system by the system effluent pipe 12.

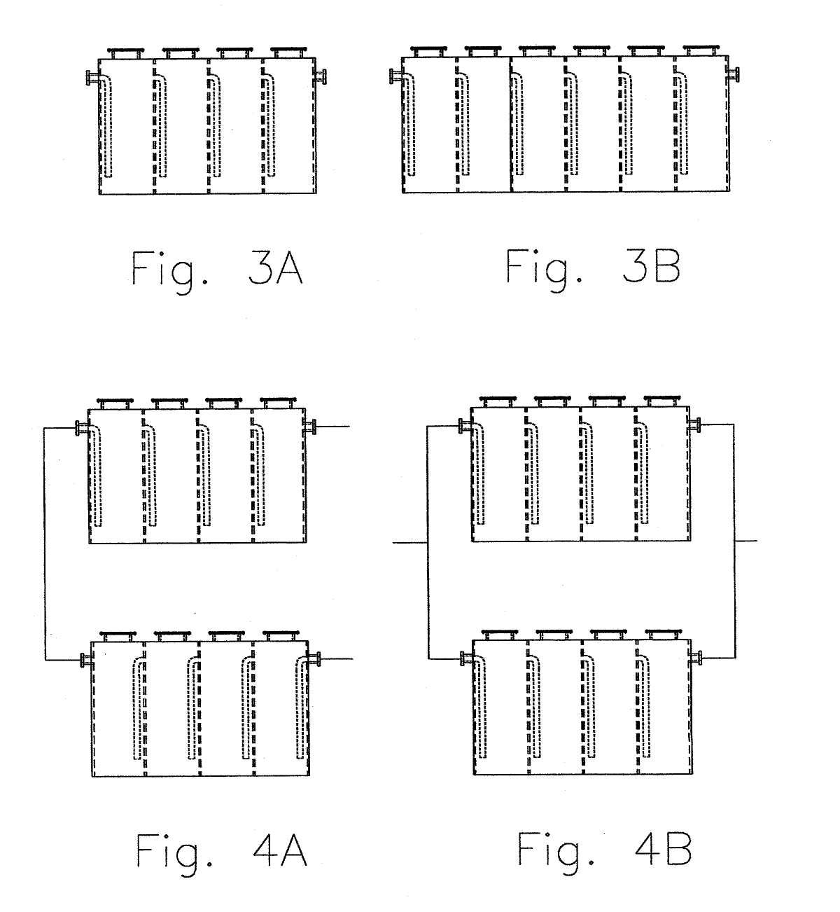

FIGS. 3-5—Additional Embodiments

This system maximizes flexibility in its construction, operation, and functionality. The system may be constructed of any number of materials including, concrete, fiberglass, plastic, steel, etc. It may be operated as a permanent or temporary system. It may be constructed above ground, below ground, or on a portable device. The number of cells in each system can vary from two to many. FIG. 3A shows a schematic for a four cell system and FIG. 3B shows a schematic for a six cell system. Multiple systems can be established to operate in series or parallel, FIG. 4A shows a schematic of a series configuration and FIG. 4B shows a schematic of a parallel configuration.

The size, design flow rates, and treatment capacity of the systems can vary. The flexibility of the system allows it to be modified during its life cycle to maximize its effectiveness. Any combination of cells can be used in the system. One such embodiment is a six cell system with the first cell an oil water separator cell, the next four cells air stripper cells, and the final cell a carbon cell.

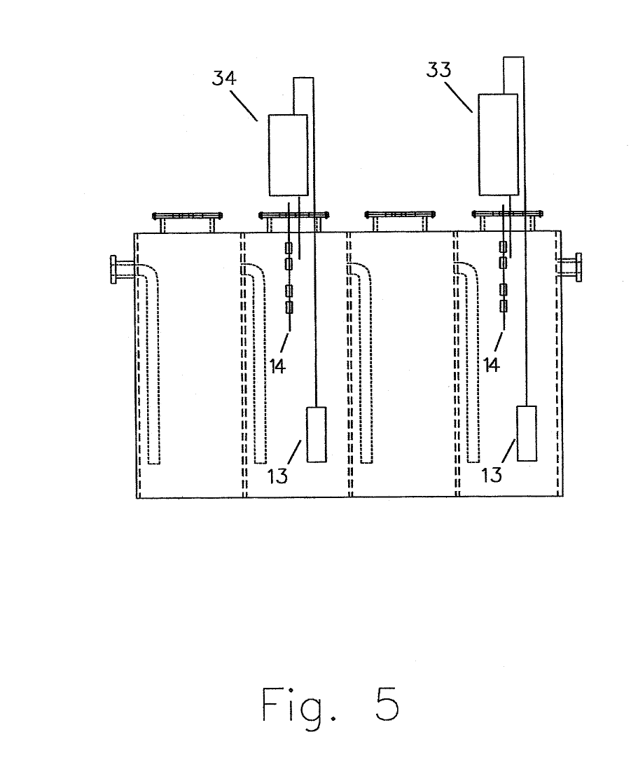

Traditional remediation equipment can be added to this system. FIG. 5 shows a schematic of one such embodiment. A tradition air stripper 33 and a traditional carbon vessel 34 could use a submersible pump 13 and water level control assembly 14 to control the water level and move water through them. Water treated with these traditional systems could then flow back into any of the cells in the system. This can increase treatment capacity and effectiveness.

In addition to the knock out cell air stripper cell, carbon cell, biological treatment cell, and nutrient injection cell described in the preferred embodiment, there are many additional embodiments of each cell. A sand filter cell is constructed in a similar configuration to the carbon cell, with sand replacing the carbon. Several variations of the biological treatment cell could use different material such as carbon, pumice, or other materials to provide surface area.

Air lift pumps could be used in any of the cells to circulate, oxygenate, and/or mix water and other materials in the water. Cells could be used as oil water separators, settling tanks and for storage of water. Any cell could use pressure, vacuum, or siphon to control the level and flow of water and air. A siphon is established by using a down pipe attached to the influent to drain the previous cell to the level of the down pipe.

### CONCLUSION, RAMIFICATIONS, AND SCOPE

Thus the reader will see the remediation system of the invention provides a flexible device that allows the use of a plurality of treatment technologies. Technology changes may be made as needed to maximize efficiency. The system may be modified to apply the most appropriate treatment technology. Dynamic water conditions may justify such changes in technologies. Changing technologies requires only minor modifications to the system configuration. The system is constructed in such a way as to allow these changes with minimal effort or cost.

An example of operation is an initial configuration as described in the preferred embodiment. In the initial configuration, the five celled system uses five treatment technologies. Settling is used in the first cell, air stripping in second, carbon adsorption in third, biological treatment in fourth, and nutrient injection in the fifth. As changing water conditions may warrant, the system may be modified to maximize efficiency. Then, a second phase of operation may use three technologies; oil water separation in first cell, air stripping in second through fourth, and carbon adsorption in the fifth. A final phase of operation may use two technologies: oil water separation in the first cell, and carbon adsorption in the second through fifth. Thus, a phased approached is used to most appropriately treat the dynamic water conditions.

While my above description contains many specificities, these should not be construed as limitations on the scope of the invention, but rather as an exemplification of the preferred embodiments thereof. Many other variations are possible.

Accordingly, the scope of the invention should be determined not by the embodiments illustrated, but by the appended claims and their legal equivalents.

I claim:

1. A flexible remediation system for treating water comprising:
a. a tank for the treatment of water entering said tank,
b. a plurality of cells in said tank,
c. a connective means to provide serial liquid flow from the first cell to the last cell in said tank,
d. a opening to each cell for the installation of a selected remediation technology,
e. a remediation technology in at least one said cell, whereby said system can be operated with a plurality of remediation technologies to maintain high operating efficiencies over a large range of water conditions in a cost effective manner.

2. The system of claim 1 wherein said system has five said cells.

3. The system of claim 2 wherein said tank is cylindrical and comprised of steel material.

4. The system of claim 3 wherein said opening to each said cell is a manway with a plurality of individual ports.

5. The system of claim 4 wherein said connective means to provide serial liquid flow are pipes connecting the lower section of a cell to the upper section of the subsequent cell.

6. The system of claim 5 wherein said pipes are at a level as to maintain the level of water in all the cells at substantially the same level whereby gravity controls the flow through the cells.

7. The system of claim 1 wherein said system has a plurality of said tanks connected in series.

8. The system of claim 1 wherein said system has a plurality of said tanks connected in parallel.

9. The system of claim 1 wherein at least one of said cell's remediation technology is selected from the group consisting of solids settling, oil-water separation, air stripping, carbon adsorption, biological degradation, filtration, and nutrient injection.

10. The system of claim 1 wherein said tank is located from the group consisting of buried below ground surface, mounted on a portable device, and installed above ground surface.

11. The system of claim 1 wherein said system has a conventional water treatment technology connected through said opening.

12. A flexible remediation system for treating water comprising of a multi-celled tank for the treatment of water entering said tank, a means providing serial liquid flow from the first cell to the last cell of said tank, access to each cell to provide installation of a plurality of remediation technologies and to allow maintenance access to said cells, whereby said system can be modified to adapt to current water conditions.

13. The system of claim 13 wherein said system has five said cells.

14. The system of claim 14 wherein said tank is cylindrical and comprised of steel material.

15. The system of claim 15 wherein said connective means to provide serial liquid flow are pipes connecting the lower section of a cell to the upper section of the antecedent cell.

16. The system of claim 16 wherein said pipes are at a level as to maintain the level of water in all the cells at substantially the same level whereby gravity controls the flow through the cells.

17. The system of claim 13 wherein at least one of said cell's remediation technology is selected from the group consisting of solids settling, oil-water separation, air stripping, carbon adsorption, biological degradation, filtration, and nutrient injection.

18. The system of claim 13 wherein said system has a plurality connected in a manner selected from the group consisting of series and parallel.

19. The system of claim 13 wherein said tank is located from the group consisting of buried below ground surface, mounted on a portable device, and installed above ground surface.

20. The system of claim 13 wherein said system has a conventional water treatment technology connected through said access.
